(19) United States
(12) Patent Application Publication
(10) Pub. No.: US 2016/0300220 A1
(43) Pub. Date: Oct. 13, 2016

(54) SYSTEM AND METHOD FOR ENABLING A SECURE TRANSACTION BETWEEN USERS

(71) Applicant: Ranvir Singh Sethi, Forest Lake (AU)

(72) Inventor: Ranvir Singh Sethi, Forest Lake (AU)

(21) Appl. No.: 15/092,670

(22) Filed: Apr. 7, 2016

(30) Foreign Application Priority Data
Apr. 7, 2015 (AU) AU2015901246

(51) Int. Cl. G06Q 20/36; G06Q 20/32; G06Q 20/38; G06Q 20/10

(52) U.S. Cl. CPC G06Q 20/367; G06Q 20/10; G06Q 20/322; G06Q 20/3829

(57) ABSTRACT

A system for enabling a secure transaction between a first user and a second user is disclosed. The system includes a first device. The first device includes (i) a memory and (ii) a processor. The memory stores (a) database, (b) a set of modules, and (c) instructions. The set of modules include a first device token obtaining module, a first device encryption key obtaining module, a first device long token communicating module, a first device long token receiving module, a first device payment transfer information receiving module, a first device transaction information encryption module, a first device encrypted transaction information associating module, a first device payment transfer information communicating module, a first device transaction information approval module, a first device transaction reporting module, and a first device payment transfer information verification module.

### CROSS-REFERENCE TO RELATED APPLICATIONS

This application claims priority to Australian patent application no. AU2015901246 filed on Apr. 7, 2015 the complete disclosure of which, in its entirely, is herein incorporated by reference.

### BACKGROUND

1. Technical Field

The embodiment herein generally relates to a secure transaction, and more particularly, to a system and method for enabling a secure transaction between a first user and a second user.

2. Description of the Related Art

In recent years, it has become a common occurrence that users are always logged into at least one electronic device at all times. The electronic device may be a Smartphone, a tablet, a laptop, or a wearable computer like a watch, or a spectacle. Also, it is not practical for user to remember and recite its credit card and bank details while shopping, and for this reason it has to always have a card with a microchip or magnetic tape for fast reading of the data, in personal possession. These cards can be read by special point of sale devices only. In some cases, the user is not able to retrieve money from an Automatic Teller Machine without the physical card. A transaction of amount may be failed or locked when the user inputs the transaction information in the automatic teller machine by mistake.

Regarding the shopping, consumers may conduct online payment transactions using mobile devices. For example, a consumer may download a merchant application and select some items to purchase. Then, to conduct the payment transaction, the consumer may enter payment information using a physical or on-screen keyboard. However, the manual entry of payment information to merchant applications is often redundant, as the consumer may already have payment information stored in a secure storage medium. Further, the manual entry of payment information may introduce security risks such as a vulnerability to eavesdropping.

Accordingly, there is a need to allow the consumer to use secure payment credentials stored on a mobile device to initiate and process a transaction. However, the payment credentials stored on the mobile device are sensitive and the merchant applications on the mobile device may be open to hacking, spoofing, and other security threats. As such, there is a need to ensure the payment credentials stored securely on the mobile device are secured against potential malicious applications and threats on the mobile device during payment transaction processing.

Furthermore, traditional transactions have limited security features and a higher risk of fraud because the consumer is not present at a merchant or a service provider for verification that the payment credentials have not been stolen or intercepted and are not being used by a malicious third party.

In case of a bank transaction, for the user with a bank account is it highly inconvenient to change its bank account from one bank to another bank as each time the account number gets changed, the user has to report the new bank account number to all parties that are using the old number for direct debit or direct credit into the account for the transaction.

Accordingly, there is a need for enabling a secure transaction between users, wherein the users can easily and quickly share the token verbally or otherwise without exposing their devices to other devices for machine to machine transmission of tokens that completes transaction between users even if internet is not available to or both users' devices.

### SUMMARY

In view of a foregoing, an embodiment herein provides a system for enabling a secure transaction between a first user and a second user. The system includes a first device. The first device includes (i) a memory and (ii) a processor. The memory that stores (a) database, (b) a set of modules, and (c) instructions. The processor which when configured by the instructions executes the set of modules. The set of modules includes (a) a first device token obtaining module, (b) a first device encryption key obtaining module, (c) a first device long token communicating module, (d) a first device long token receiving module, (e) a first device payment transfer information receiving module, (f) a first device transaction information encryption module, (g) a first device encrypted transaction information associating module, and (h) a first device payment transfer information communicating module. The first device token obtaining module implemented by the processor, that obtains a first long token that is specific to the first device. The first device encryption key obtaining module, implemented by the processor, that obtains a first encryption key that is specific to the first device. The first device long token communicating module, implemented by the processor, that communicates the first long token to a second device. The first device long token receiving module, implemented by processor, that receives a second long token from the second device. The first device payment transfer information receiving module, implemented by the processor, that receives payment transfer information from the second device. The payment transfer information includes the second long token of the second device. The first device transaction information encryption module, implemented by the processor, that encrypts transaction information with the first encryption key of the first device. The first device encrypted transaction information associating module, implemented by the processor, that associates the encrypted transaction information with the payment transfer information. The first device payment transfer information communicating module, implemented by the processor, that communicates the payment transfer information with the encrypted transaction information to the second device.

In one embodiment, the second device includes (i) a memory and (ii) a processor. The memory that stores (a) database, (b) a set of modules, and (c) instructions. The processor which when configured by the instructions executes the set of modules. The set of modules includes (a) a second device long token receiving module, (b) a second device transaction information associating module, (c) a second device payment transfer information communicating module, and (d) a second device payment transfer information receiving module. The second device long token receiving module implemented by the processor that receives the first long token from the first device. The second device transaction information associating module, implemented by the processor, that (i) allows the second user to at least one of (a) enter the transaction information, or (b) approve the transaction information, and (ii) associates the transaction information with the payment transfer information. The second device payment transfer information communicating module, implemented by the processor that communicates the payment transfer information with the transaction information to the first device. The second device payment transfer information receiving module, implemented by the processor that receives the payment transfer information with the encrypted transaction information from the first device.

In another embodiment, the second device further includes a second device token associating module, implemented by the processor, that (i) associates the first long token with the payment transfer information, or (ii) associates the second long token with the payment transfer information.

In yet another embodiment, the second device further includes a second device long token communicating module, implemented by the processor that communicates the second long token to the first device.

In yet another embodiment, the first device is a payee device.

In yet another embodiment, the first device is a payer device.

In yet another embodiment, the second device is the payer device when the first device is the payee device.

In yet another embodiment, the second device is the payee device when the first device is the payer device.

In yet another embodiment, the first device further includes a first device transaction information approval module, implemented by the processor that approves the transaction information, or (b) allows entering of the transaction information.

In yet another embodiment, the first device further includes a first device transaction reporting module, implemented by the processor that reports the transaction between the first user and the second user to the server when internet access is available.

In yet another embodiment, the second device includes a second device transaction reporting module, implemented by the processor that reports the transaction between the second user and the first user to the server when the internet access is available.

In yet another embodiment, the payment transfer information further includes a transaction amount.

In yet another embodiment, the encrypted transaction information includes at least one of (a) a password, (b) the transaction amount that is to be transacting from the first user to the second user or from the second user to the first user, or (c) authentication information.

In yet another embodiment, the first device includes a payment transfer information verification module that verifies the payment transfer information whether the payment transfer information is encrypted using predefined rules of encryption, or the payment transfer information verification module further verifies the second long token received from the second device that meets the predefined rules for a long token.

In one aspect, a system for secure transaction between a first user and a second user, the system includes a first device. The first device includes (i) a memory and (ii) a processor. The memory that stores (a) database, (b) a set of modules, and (c) instructions. The processor which when configured by the instructions executes the set of modules. The set of modules includes (a) a first device long token receiving module, (b) a first device token associating module, (c) a first device long token communicating module, (d) a first device transaction information associating module, (e) a first device payment transfer information communicating module, and (f) a first device payment transfer information receiving module. The first device long token receiving module, implemented by the processor, that receives a second long token from a second device. The first device token associating module, implemented by the processor, that (i) associates the second long token with payment transfer information or (ii) associates a first long token with the payment transfer information. The payment transfer information includes first long token of the first device, the second long token of the second device, or a transaction amount. The first device long token communicating module, implemented by the processor, that communicates the first long token to the second device. The first device transaction information associating module, implemented by the processor, that (i) allows the first user to at least one of (a) enter the transaction information, or (b) approves the transaction information and associates the transaction information with the payment transfer information. The first device payment transfer information communicating module, implemented by the processor, that communicates the payment transfer information with the transaction information to the second device. The first device payment transfer information receiving module, implemented by the processor, that receives the payment transfer information with the encrypted transaction information from the second device.

In one embodiment, the second device includes (i) a memory and (ii) a processor. The memory that stores (a) database, (b) a set of modules, and (c) instructions. The processor which when configured by the instructions executes the set of modules. The set of modules includes (a) a second device token obtaining module, (b) a second device encryption key obtaining module, (c) a second device long token communicating module, (d) a second device long token receiving module, (e) a second device payment transfer information receiving module, (f) a second device transaction information encryption module, (g) a second device encrypted transaction information associating module, and (h) a second device payment transfer information communicating module. The second device token obtaining module, implemented by the processor, that obtains the second long token that is specific to the second device. The second device encryption key obtaining module, implemented by the processor, that obtains a second encryption key that is specific to the second device. The second device long token communicating module, implemented by the processor, that communicates the second long token to the first device. The second device long token receiving module, implemented by the processor, that receives the first long token from the first device. The second device payment transfer information receiving module, implemented by the processor, that receives the payment transfer information from the first device. The second device transaction information encryption module, implemented by the processor, that encrypts the transaction information with the second encryption key of the second device. The second device encrypted transaction information associating module, implemented by the processor, that associates the encrypted transaction information with the payment transfer information. The second device payment transfer information communicating module, implemented by the processor, that communicates the payment transfer information with the encrypted transaction information to the first device.

In one embodiment, the first device is a payer device and the second device is the payee device when the first device is the payer device, and the first device is a payee device and the second device is the payer device when the first device is the payee device.

In another embodiment, the second device further includes (a) a second device transaction information approval module, (b) a second device transaction reporting module, and (c) a payment transfer information verification module. The second device transaction information approval module, implemented by the processor, that approves the transaction information or (b) allows entering of the transaction information. The second device transaction reporting module, implemented by the processor, that reports the transaction between the second user and the first user to a transacting server when internet access is available. The payment transfer information verification module that verifies the payment transfer information whether the payment transfer information is encrypted using predefined rules of encryption. The payment transfer information verification module further verifies that the first long token received from the first device that meets the predefined rules for a long token.

In another aspect, a computer implemented method for transacting information securely from a first user to a second user, the method includes (a) obtaining, using a first device, a first long token that is specific to the first device, (b) obtaining, using the first device, a first encryption key that is specific to the first device, (c) communicating, using the first device, the first long token to a second device, (d) associating, using the second device, the first long token or a second long token with payment transfer information, (e) associating, using the second device, the transaction information with the payment transfer information, (f) communicating, using the second device, the payment transfer information with the transaction information to the first device, (g) encrypting, using the first device, the transaction information using the first encryption key of the first device, (h) associating, using the first device, the encrypted transaction information with the payment transfer information in first device, and (i) communicating, using the first device, the payment transfer information with the encrypted transaction information to the second device. The payment transfer information includes at least one of (i) the first long token of the first device, (ii) the second long token of the second device, or a transaction amount.

In yet another embodiment, verifying that the first user or the second user enters the first short token and the transaction information that is matched by unencrypted part of the payment transfer information in the second device, (b) verifying the payment transfer information whether the payment transfer information are encrypted using predefined rules of encryption, and (c) verifying the second long token received from the second device that meets the predefined rules for a long token.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following detailed description with reference to the drawings, in which:

FIG. 1 illustrates a system view of a first user interacting with a second user to enable a secure transaction according to an embodiment herein;

FIG. 2 illustrates an exploded view of a first device of FIG. 1, according to an embodiment herein;

FIG. 3 illustrates an exploded view of a second device of FIG. 1, according to an embodiment herein;

FIGS. 4A-4C are flow charts that illustrate a method for secure transaction using communicating long token and short token between the first device and the second device of FIG. 1, according to an embodiment herein;

FIG. 5A is a user interface view that illustrates an unmanifested side of the first device, and the second device of FIG. 1 according to an embodiment herein;

FIG. 5B is a user interface view that illustrates the unmanifested side of the first device, and the second device of FIG. 1 according to an embodiment herein;

FIGS. 6A-6B are user interface views of short token generated and authenticated between the first device and the second device for the secure transaction of FIG. 1, according to an embodiment herein;

FIGS. 7A-7B are flow diagrams that illustrate a method for enabling a secure transaction between a first user and a second user, according to an embodiment herein;

FIG. 8 illustrates an exploded view of a receiver used in accordance with the embodiments herein; and

FIG. 9 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skilled in the art to practice the embodiments herein. Accordingly, the examples should not be construed as limiting the scope of the embodiments herein.

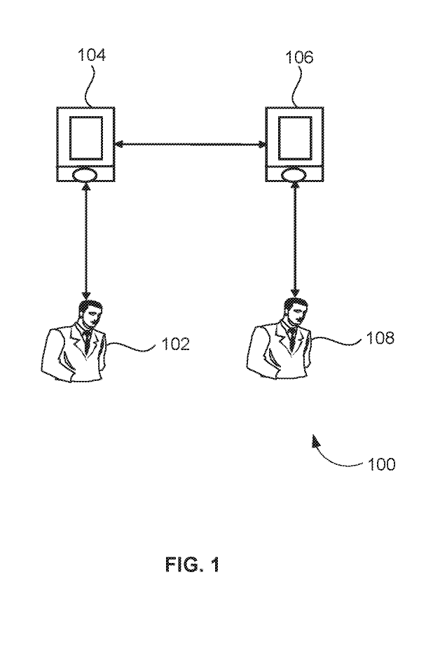

As mentioned, there remains a need for a system for enabling a secure transaction between a first user and a second user. Referring now to the drawings, and more particularly to FIGS. 1 to 9, where similar reference characters denote corresponding features consistently throughout the figures, these are shown preferred embodiments.

FIG. 1 illustrates a system view 100 of a first user 102 interacting with a second user 108 to enable a secure transaction according to an embodiment herein. The system view 100 includes the first user 102, a first device 104, a second device 106, and the second user 108. The first user 102 interacts with the second user 108 with a smart phone, a computer or both, or such computation devices. In one embodiment, the first device 104 obtains a long token that is specific to the first device 104, whereas second device 108 receives the long token from the first user 102 or the first device 104. In one embodiment, the long token is communicated between the first device 104 and the second device 106 ultrasonically. In one embodiment the first user 102 is a payer and the second user 108 is a payee. In one embodiment, the first device 104 is the payer device and the second device 106 is the payee device. In one embodiment, the first user 102 is a payee and the second user 108 is a payer and the first device 104 is a payee device and the second device 106 is a payer device. In an embodiment, a user may be the payer, the payee, or both. The user may decide to be the payer or the payee, that is, the first user 102 may obtain a token from a transacting server and share it with the second user 108 to transfer funds or receive funds, that is, the first user 102 may be the payer and or the payee, within the same embodiment.

In an embodiment, the long token is unique and non-repeatable. Such long token can be easily generated as long random alphanumeric numbers whose probability of being repeated is statistically negligible. For example, an example the long token “ZX580435834058-3434” of nineteen characters where first two characters may be alphabets or numbers, and the last four are digits may be an alphabets or numbers. A few long tokens are pre-present in the devices for transacting when internet is not available. A few encryption keys are pre-present in the devices for transacting when internet is not available. In an embodiment, these long tokens and the encryption keys are already known to the transacting server. Thus, the encryption keys and the long tokens are generating either in at least one of (a) the transacting server, (b) the devices, or (c) in a third device, but obtained by the devices and shared with the transacting server or obtained by the transacting server and shared with the devices, whenever the devices includes internet connectivity. Hence, now the first device 104 is prepared to transact with the second device 106 even when the first device 104 does not have internet access. The payer is sought an approval prior to processing a payment wherein in an embodiment identifier of the payee is disclosed to the payer. Hence regardless of whether the short token is shared by the payer to the payee or the payee to the payer, the payer provides explicit approval prior to completion of transaction. In an embodiment, the approval is being provided by the payer to the payee directly without the transacting server. The approval displays payee identifier or a transaction amount or both to the payer. The payer may input the transaction amount that would imply approval. In an embodiment payee enters the amount before the payer and the payer approves that transaction amount. In an embodiment payer enters the amount before the payee and the payee approves that transaction amount. In an embodiment, the short token may be drawings, numbers, symbols, catch phrase and the like. In an embodiment the short token is shared by the payer to the payee and the payee to the payer, which leads to mutual matching of each other's short tokens.

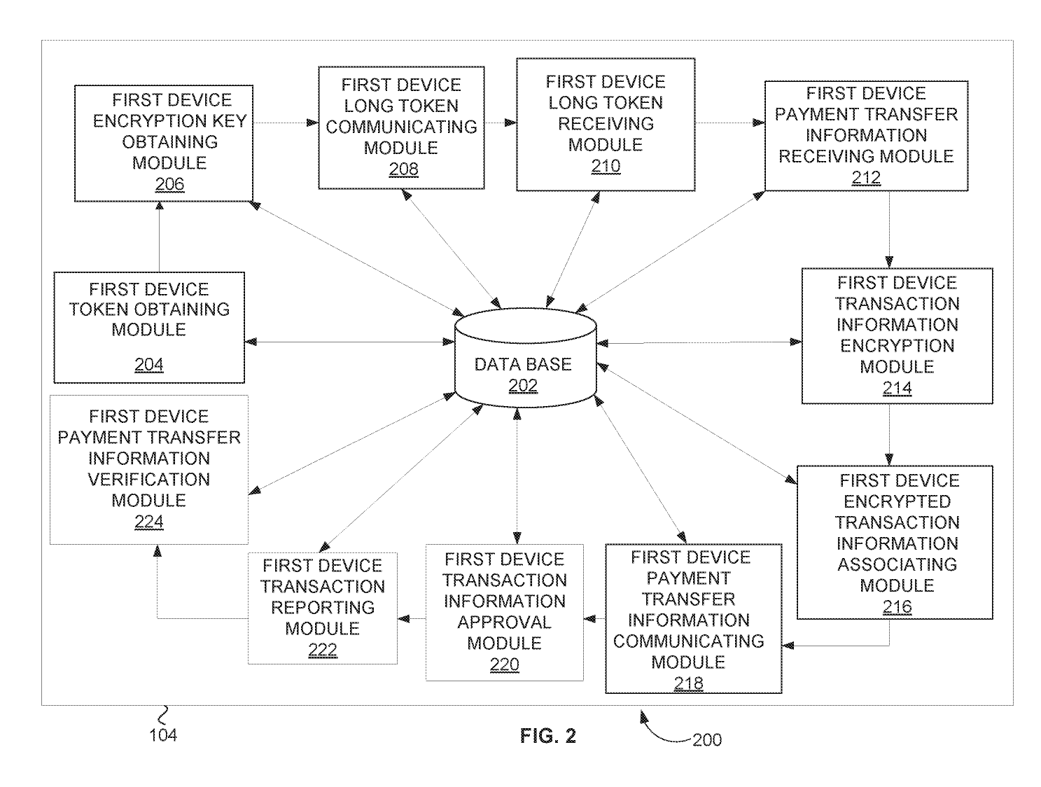

FIG. 2 illustrates an exploded view 200 of a first device 104 of FIG. 1, according to an embodiment herein. The exploded view 200 includes a database 202, a first device token obtaining module 204, a first device encryption key obtaining module 206, a first device long token communicating module 208, a first device long token receiving module 210, a first device payment transfer information receiving module 212, a first device transaction information encryption module 214, a first device encrypted transaction information associating module 216, a first device payment transfer information communicating module 218, a first device transaction information approval module 220, a first device transaction reporting module 222, and a first device payment transfer information verification module 224. The database 202 includes transaction information related to the first device 104. The first device token obtaining module 204, implemented by the processor, that obtains a first long token that is specific to the first device 104. In one embodiment, the first device token obtaining module 204 is configured to obtain the first long token from at least one of (a) the first device 104, (b) a transacting server, or (c) a third party device. In one embodiment, the first long token is associated with a first short token. The first short token is authenticated between the first device 104 and the second device 106 for mutual confirmation of transaction. The first device encryption key obtaining module 206, implemented by the processor, that obtains a first encryption key that is specific to the first device 104. The first device encryption key obtaining module 206 obtains the first encryption key from at least one of (a) the first device 104, (b) the transacting server, or (c) the third party device. The first device long token communicating module 208, implemented by the processor that communicates the first long token to a second device 106. The first device long token receiving module 210, implemented by the processor that receives a second long token from the second device 106. The first device payment transfer information receiving module 212, implemented by the processor, that receives payment transfer information from the second device 106. In one embodiment, the second long token is associated with a second short token. The second short token is authenticated between the second device 106 to the first device 104 for the mutual confirmation of transaction. The payment transfer information includes at least one of (a) the second long token of the second device 106, or (b) a transaction amount. The first device transaction information encryption module 214, implemented by the processor, that encrypts transaction information with the first encryption key of the first device 104. For example, encrypts amount to be transacted between the first user 102 and the second user 108, encrypts a password to be shared from the first user 102 to the second user 108 or a business card of the first user 102. This encryption is performed using the first device encryption key. The first device encrypted transaction information associating module 216, implemented by the processor, that associates the encrypted transaction information with the payment transfer information. For example, payment transfer information may have minimum set of information to determine by the transacting server which the two users transacted for what amount, thereby containing the long token of the first device 104, encrypted amount encrypted using first device's key. When the payment transfer information is sent from the second device 106 on a secure connection to the transacting server, the transacting server knows the identity of second user 108 automatically, and the first user 102 details can be determined from details in the payment transfer information. The payment transfer information may also include unencrypted amount or long tokens of both users. The encryption key of a device is never shared with the other device. Hence, the encrypted transaction information associating module 216 associates the long token of the first device 104, encrypted amount encrypted using first device's key and unencrypted amount with each other. In an embodiment, this association may involve appending them into a single file that is shared with the second device 106. In one embodiment, the encrypted transaction information includes at least one of (a) a password, (b) the transaction amount that is to be transacting from the first user 102 to the second user 108 or from the second user 108 to the first user 102, or (c) authentication information. In one embodiment, the authentication information can be a business card and an encrypted identity is decrypted by the transacting server, hence the user can only share a true identity. For example instead of transaction amount, the password can be encrypted and sent to the second user 108 by the first user 102 and the second user 108 sends the password to the transacting server without knowing the password itself. The transacting server logs in the second user 108 and the password supplied by the first user 102 but not revealed to second user 108. For example, in a hotel, a temporary password is given for each room and each day to get new passwords for each room guest. Using the system, the encrypted file of password and an encrypted expiry date are given to login to the room guest. The room guest can send encrypted file via Wifi modem/router to network server each time to login. Hence, the room guest never knows the password and when the encrypted expiry date is reached, the login stops working. All hotel needs is a bunch of encryption keys that are also stored in the transacting server. The first device payment transfer information communicating module 218, implemented by the processor, that communicates the payment transfer information with the encrypted transaction information to the second device 106. The first device transaction information approval module 220, implemented by the processor, that (a) approves the transaction information or (b) allows entering of the transaction information. The approval is achieved based on unencrypted amount being displayed on the payer device and the payer auctioning approval by tapping on “Approve” or the amount entered by the payer is matched with unencrypted amount. The unencrypted amount is entered by the payee and shared by the payee device with the payer device. Once the first device transaction information approval module 220 receives approval, the approval is communicated to the payee device which further appends or associates it with payment transfer information using encrypted transaction information associating module 216. Once the approval is successfully communicated from the payer device to the payee device, both devices display ‘transaction successfully completed’ message, regardless of internet availability. The first device transaction reporting module 222, implemented by the processor, that reports the transaction between the first user 102 and the second user 108 to the transacting server when internet access is available. The first device payment transfer information verification module 224 that verifies the payment transfer information whether the payment transfer information is encrypted using predefined rules of encryption. The first device payment transfer information verification module 224 further verifies the second long token received from the second device 106 that meets the predefined rules for a long token. In one embodiment, the payment transfer information includes an approval option for recurring payment between the first user 102 and the second user 108. The transaction amount of the payment transfer information is encrypted by the payer using payer's encryption key. The payee device doesn't know whether the payment transfer information includes gibberish or an actual amount. The transaction is failed at the transacting server when the payer is sending the gibberish or the actual amount. However, the encrypted part, though it might look like gibberish, follows certain rules. For example, the encrypted number part of the string is multiple of a large prime number. There can be more than one rule, another rule could be last three digits are divisible by 23. These rules can be changed from time to time by the transacting server. Hence, anyone wanting to send the gibberish, needs to know these rules. The payment transfer information is fake and rejected by the payee device when the payment transfer information received by the payee device does not pass these tests of encrypted amount. Hence, the payee device rejects the fake payment transfer information. For this to work, the payee device need not know payer's encryption key, only the server rules of encryption of amount. Similarly, payer long token is tested for meeting some predefined rules set by the transacting server and along token not meeting those rules is rejected by the payee device. Hence, fraud is difficult for the payer.

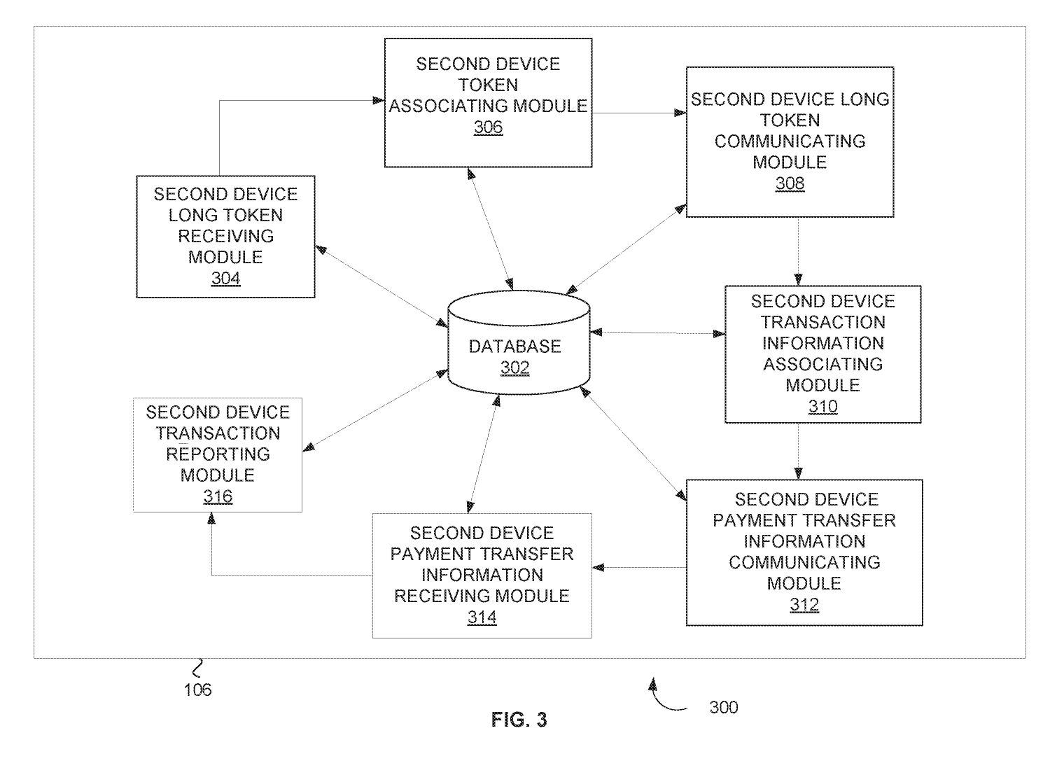

FIG. 3 illustrates an exploded view 300 of a second device 106 of FIG. 1, according to an embodiment herein. The exploded view 300 includes a database 302, a second device long token receiving module 304, a second device token associating module 306, a second device long token communicating module 308, a second device transaction information associating module 310, a second device payment transfer information communicating module 312, a second device payment transfer information receiving module 314, and a second device transaction reporting module 316. The database 302 includes transaction information related to the second device 106. The second device long token receiving module 304, implemented by the processor, that receives said first long token from the first device 104. The second device token associating module 306, implemented by the processor that (i) associates the first long token with the payment transfer information or (ii) associates the second long token with the payment transfer information. The second device long token communicating module 308, implemented by the processor, that communicates the second long token to the first device 104. The second device transaction information associating module 310, implemented by the processor, that (i) allows the second user 108 to at least one of (a) enter the transaction information, or (b) approves the transaction information, and (ii) associates the transaction information with the payment transfer information. The second device payment transfer information communicating module 312, implemented by the processor, that communicates the payment transfer information with the transaction information to the first device 104. The second device payment transfer information receiving module 314, implemented by the processor that receives the payment transfer information with the encrypted transaction information from the first device 104. In an embodiment, the encryption is performed using first device encryption key. The second device transaction reporting module 316, implemented by the processor, that reports the transaction between the second user 108 and the first user 102 to the transacting server when the internet access is available. In one embodiment, the transaction between the first user 102 and the second user 108 is reported to the transacting server from either or both the first device 104 and the second device 106 at a time when the internet access is available. Hence, if one of the devices is destroyed, the surviving device can still report the transaction to the transacting server. In one embodiment, the first device 104 and the second device 106 display a transaction successful message when the transaction is completed. The system effectively works like a cheque process where a cheque if validly signed might still bounce when presented to the bank, but a transaction was successfully completed regardless at some time in past by presenting that cheque. Likewise, a transaction may fail when payment transfer information is received by the transacting server, however, payer's liability is recorded beyond doubt, just like in the case of the paper cheque.

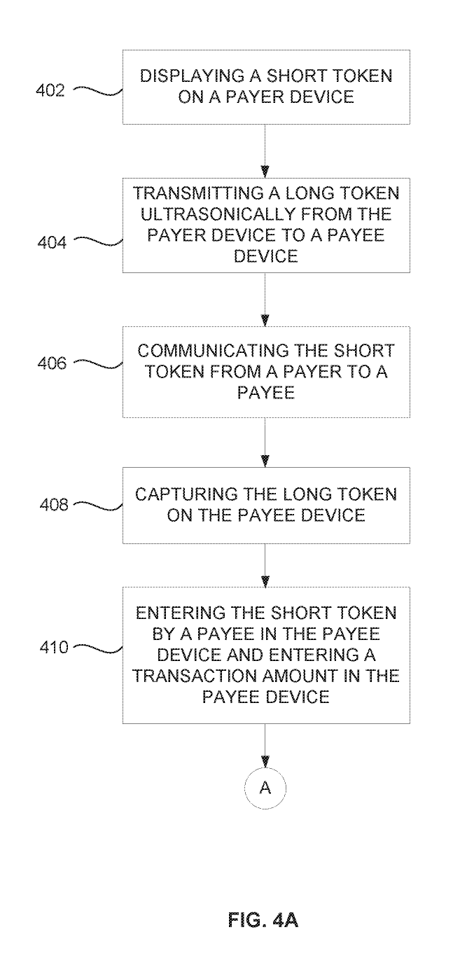

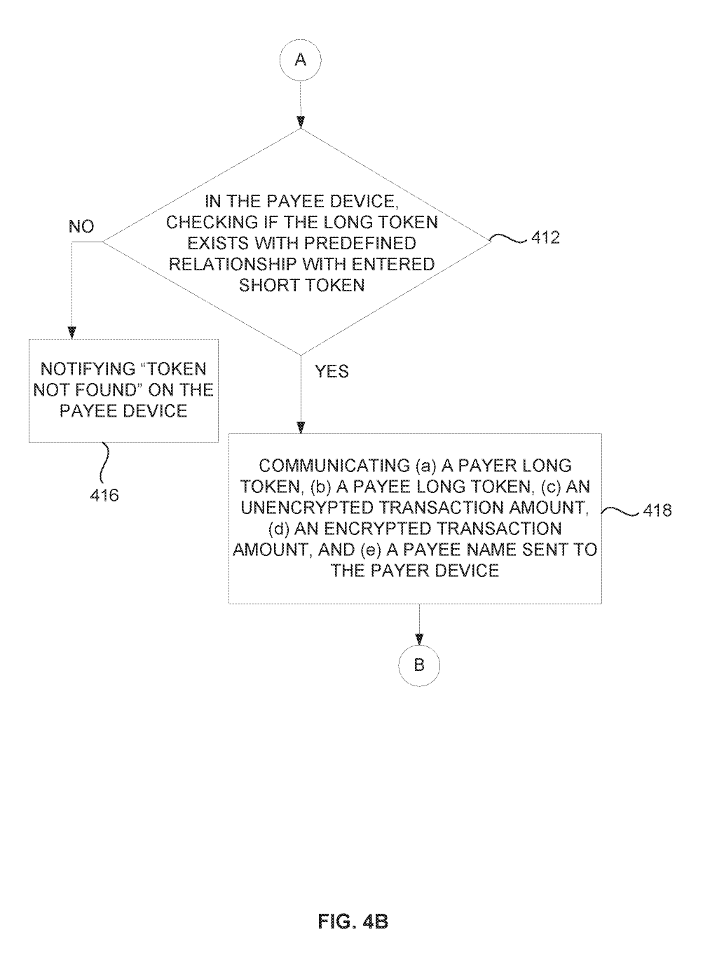

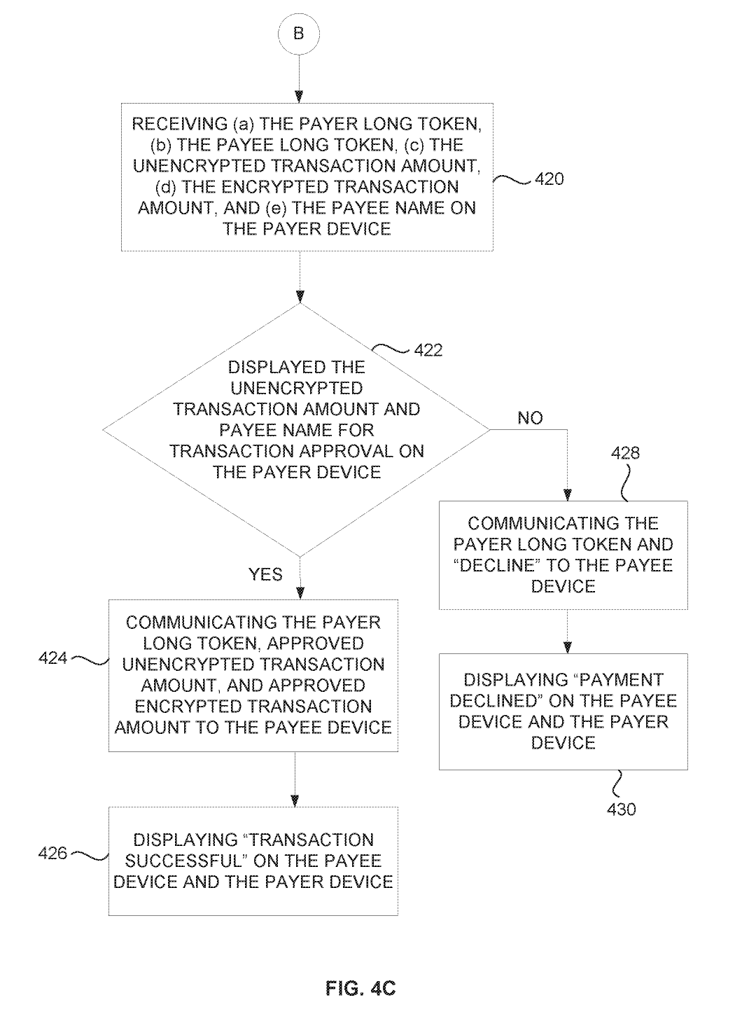

FIGS. 4A-4C are flow charts that illustrate a method for secure transaction using communicating long token and short token between the first device and the second device of FIG. 1, according to an embodiment herein. In an embodiment, the long token and short token are just random numbers or strings. The short token may be last four digits of the long token or have some other predefined relationship. In an embodiment, the short tokens are generated in at least one of (a) the transacting server, (b) the user devices, or (c) the third party device. The Long token is so long so that statistically it cannot repeat and therefore always unique. Short token is just a small four digit token that is easily communicable between the first user 102, and the second user 108. The second user 108 enters a short token that is shared from the first user 102 obtained from the first device 104. At step 402, the short token is displayed on the payer device. At step 404, the long token is ultrasonically transmitted from the payer device to the payee device. At step 406, the short token is communicated from the payer to the payee. At step 408, the long token is captured on the payee device. At step 410, the short token is entered by the payee in the payee device and also entered a transaction amount in the payee device. At step 412, it checks, whether the long token exists with predefined relationship with entered short token. If no, “token not found” message is notified on the payee device. If yes, at step 418, (a) a payer long token, (b) a payee long token, (c) an unencrypted transaction amount, (d) an encrypted transaction amount, and (e) a payee name are communicated to the payer device. At step 420, (a) the payer long token, (b) the payee long token, (c) the unencrypted transaction amount, (d) the encrypted transaction amount, and (e) the payee name are received from the payee device by the payer device. At step 422, the unencrypted transaction amount and the payee name are displayed for transaction approval on the payer device. If the unencrypted transaction amount and the payee name are displayed, the payer long token, the unencrypted transaction amount, and the approved encrypted transaction amount are communicated to payee device at step 424. If the unencrypted transaction amount and the payee name are not displayed, the payer long token, and “Decline” notification is communicated to the payee device at step 428. At step 426, “transaction successful” notification is displayed in either the pay device or the payer device. At step 430, “payment declined” notification is displayed in either the payee device or the payer device or both.

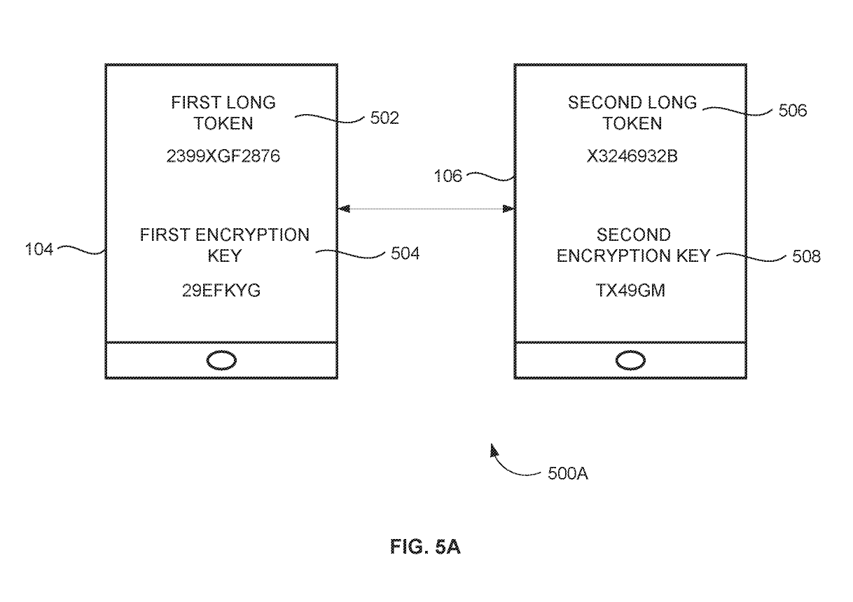

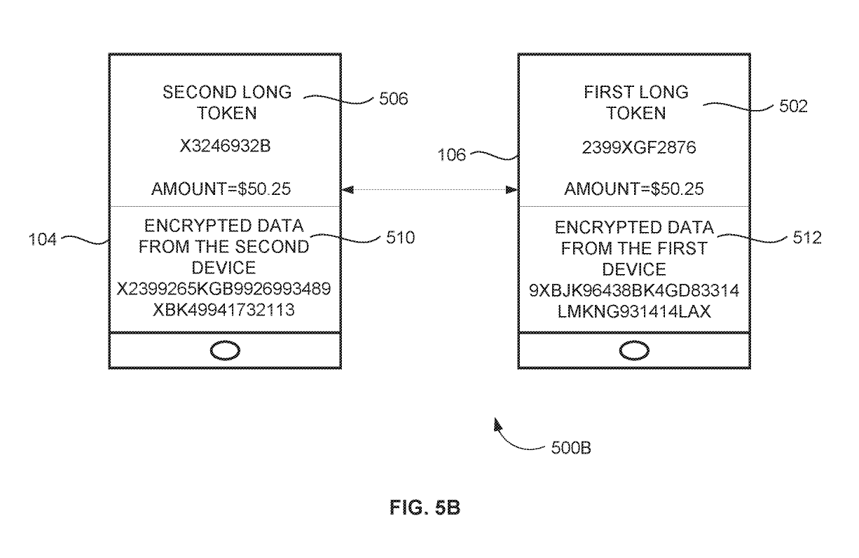

FIG. 5A is a user interface view 500A that illustrates an unmanifested side of the first device 104, and the second device 106 of FIG. 1 according to an embodiment herein. The user interface view 500A includes the first device 104, and the second device 106. The first device 104 includes a first long token 502 and a first encryption key 504. The second device 106 includes a second long token 506, and a second encryption key 508. In one embodiment, the first long token 502, the first encryption key 504, the second long token 506, and the second encryption key 508 are stored in the transacting server.

FIG. 5B is a user interface view 500B that illustrates the unmanifested side of the first device 104, and the second device 106 of FIG. 1 according to an embodiment herein. The first device 104, and the second device 106 can send the payment transfer information to the transacting server. The transacting server receives the payment transfer information from the first device 104 consisting of the second long token 506 and an encrypted data 510 from the second device 106 (i.e. encrypted using the second device encryption key 508). In an embodiment, the encrypted data 510 from the second device 106 includes an encrypted amount. The transacting server receives the payment transfer information from second device 106 consisting of the first long token 502, and an encrypted data 512 from the first device 104 (i.e. encrypted using the first device encryption key 504). In an embodiment, the encrypted data 512 from the first device 104 includes the encrypted amount. The transacting server decrypts the encrypted data 510 received from first device 104 (i.e. the encrypted using the second device encryption key 508) by finding the second encryption key 508 stored in the transacting server associated with the second long token 506 and applies the transaction in the database. Similarly, the transacting server decrypts the encrypted data 512 received from second device 106 (i.e. the encrypted using the first device encryption key 504) by finding the first encryption key 504 stored in the transacting server associated with the first long token 502 and applies the transaction in the database. If both devices send the payment transfer information to the transacting server, the transacting server can check if the transaction has already been applied by looking at date and time information in the payment transfer information. If the transaction is already processed, the second reporting of the same transaction is ignored. In an embodiment, payment transfer information will send the first long token 502 and also the second long token 504 to find if the transaction is already reported and will be more reliable than date and time of transaction. In an embodiment, the payer device can send payment transfer information encrypted by its own encryption key as an indication of his willingness to pay. Whereas, payee sends payment transfer information encrypted using payer's encryption key. In one embodiment, the transaction between the first device 104, and the second device 106 is reported to the transacting server when an internet is available.

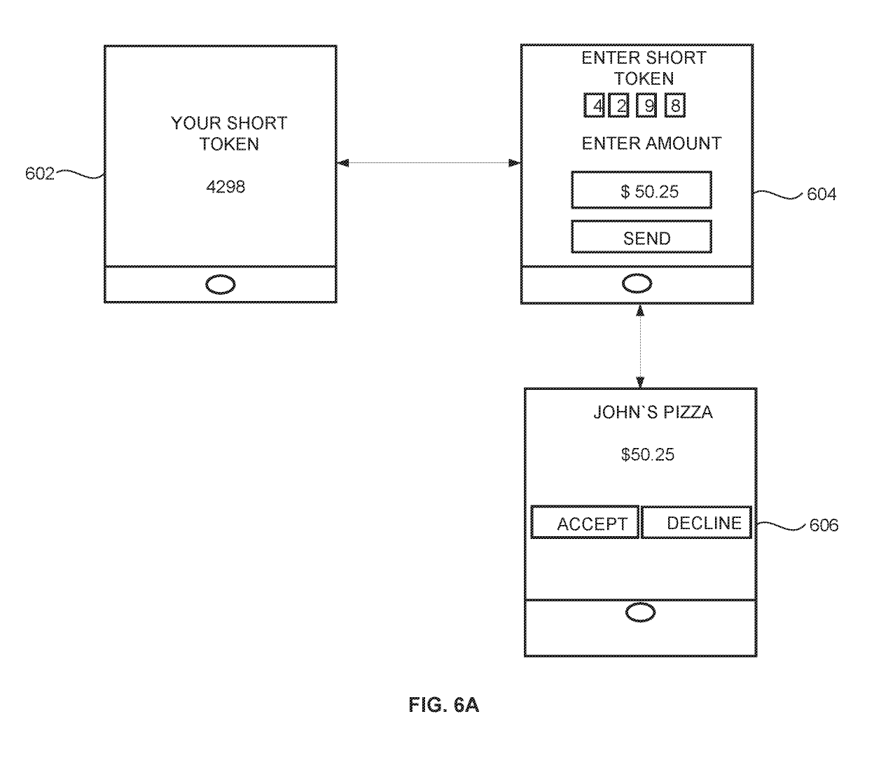

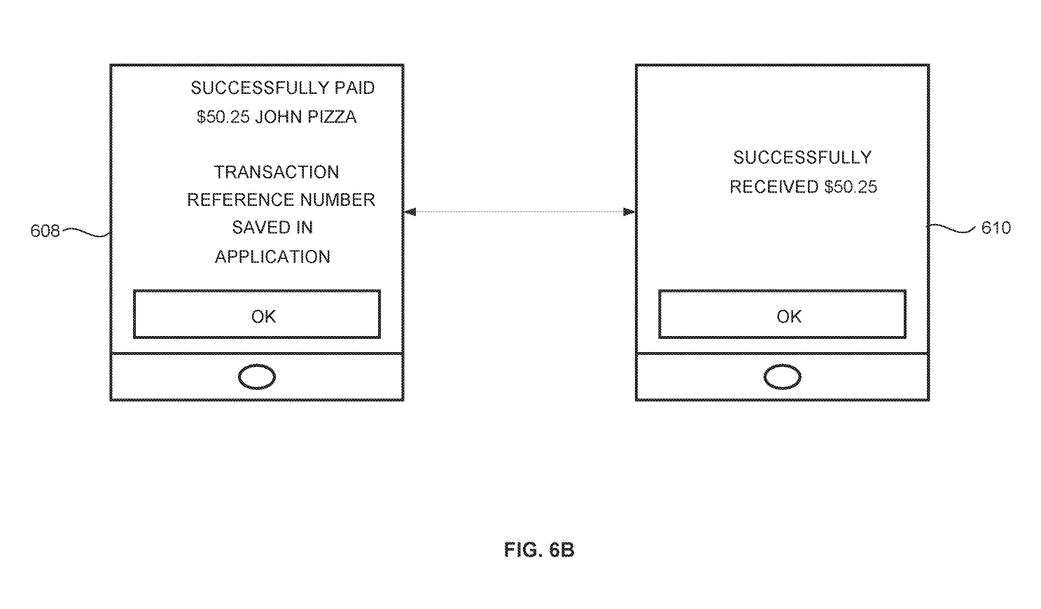

FIGS. 6A-6B are user interface views of short token generated and authenticated between the first device 104 and the second device 106 for the secure transaction of FIG. 1, according to an embodiment herein. In an embodiment, the steps performed in the user interface view are manifested to the users. In an example embodiment, at step 602, the short token is displayed in the first device 104 to transfer the amounts. The short token is shared from the first user 102 to the second user 108. At step 604, the short token, and the transaction amount are entered into the second device 106 (i.e. the payee device). The short token may be an alpha-numeric code that is shared by users verbally or a four digit code. The short token gets manifested in one device or both devices. In an embodiment, the short token is manifested in the first device 104 (i.e. the payer device) at the step 602. At step 606, the first user 102 receives the name of the second user 108 and the transaction amount. The first user 102 may accept or decline the received information. At step 608, upon the payment of the transaction amount by the first user 102 to the second user 108, the first user 102 receives a transaction reference number on processing the transaction. The transaction reference number is saved in the application. At step 610, upon the payment of the transaction amount by the first user 102 to the second user 108, the second device 106 and the first device 104 receives a successful transaction message. However, in an embodiment the long token flow may be reversed (i.e. a long token may be communicated from the second user 108 to the first user 102). In an embodiment, the options of the long token flow may be present, a payer to a payee and the payee to the payer and it is for the payer and the payee to decide how they prefer to transact. In an embodiment both users exchange each other's short tokens. In an embodiment amount may be entered by the payer. In an embodiment, amount is entered by the payee. When amount is entered by the payee, the payer approves it by interacting with an approval notification. When amount is entered by the payer, the amount is approved by the payee. In an embodiment the amount is entered by the payer or the payee, the payer must still have to approve a payee identifier by interacting with an approval notification. In an embodiment, amount is entered by the payer and the payee; the transaction amount of the payer and the payee is matched in that case, as it acts and an equivalent password, for transaction to process.

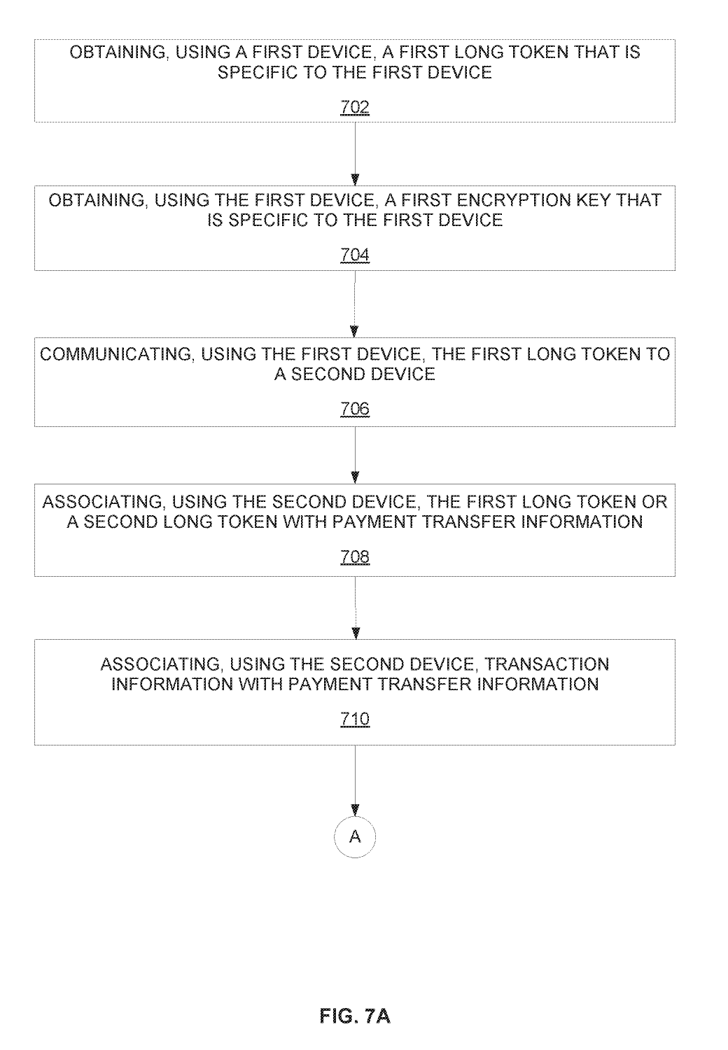

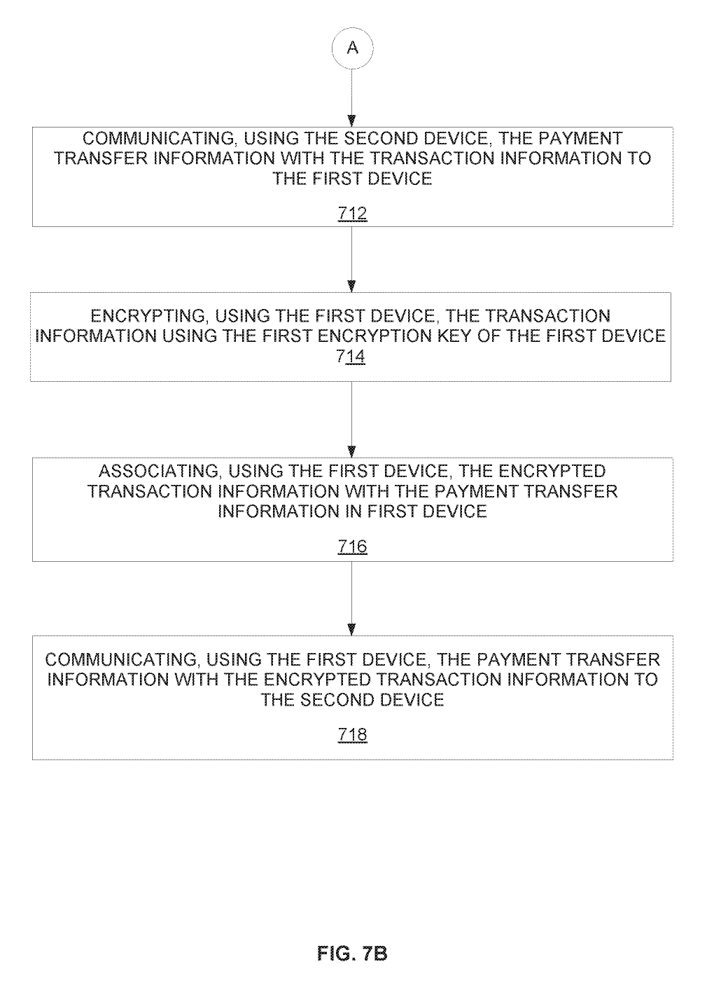

FIGS. 7A-7B are flow diagrams that illustrate a method for enabling a secure transaction between a first user 102 and a second user 108, according to an embodiment herein. At step 702, a first long token is obtained that is specific to a first device 104, using a first device 104. At step 704, a first encryption key is obtained that is specific to the first device 104, using the first device 104. At step 706, the first long token is communicated to a second device 106 using the first device 104. At step 708, the first long token or a second long token is associated with payment transfer information using the second device 106. At step 710, transaction information is associated with the payment transfer information using the second device 106. At step 712, the payment transfer information with the transaction information is communicated to the first device 104 using the second device 106. At step 714, the transaction information is encrypted using a first encryption key of the first device 104 using the first device 104. At step 716, the encrypted transaction information is associated with the payment transfer information in the first device 104 using the first device 104. At step 718, the payment transfer information with the encrypted transaction information is communicated to the second device 106 using the first device 104. In one embodiment, the first device 104 is a payee device. The second device 106 is a payer device when the first device 104 is the payee device. In another embodiment, the first device 104 is a payer device. The second device 106 is a payee device when the first device 104 is the payer device. In one embodiment, the long token is communicated between the first device 104 to the second device 106 ultrasonically. In one embodiment, the long token is communicated between the first device 102 and the second device 106 using NFC or QR code.

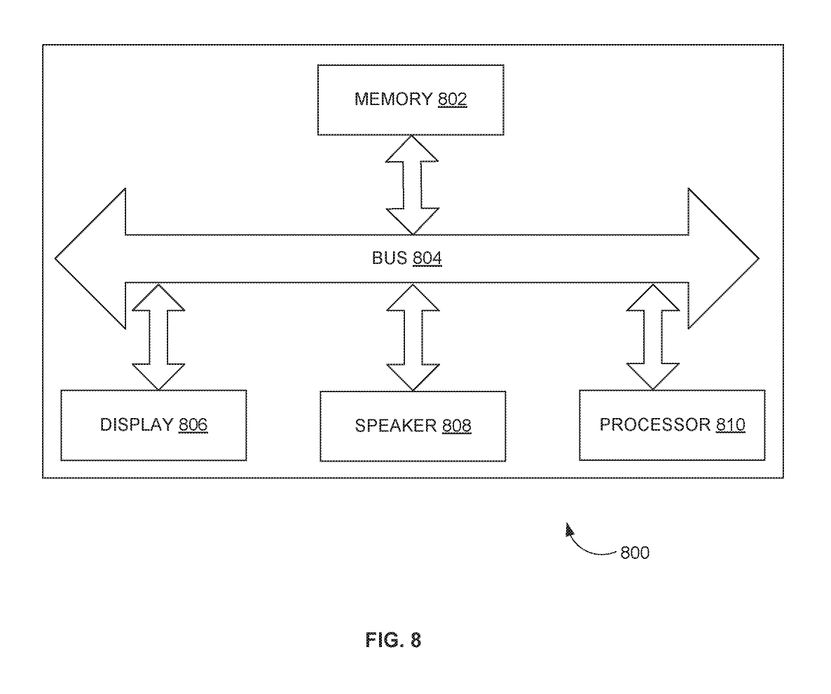

FIG. 8 illustrates an exploded view 800 of the receiver of FIG. 1 having a memory 802 having a set of instructions, a bus 804, a display 806, a speaker 808, and a processor 810 capable of processing the set of instructions to perform any one or more of the methodologies herein, according to an embodiment herein. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user of the receiver 800 may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the receiver using the bus 804.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

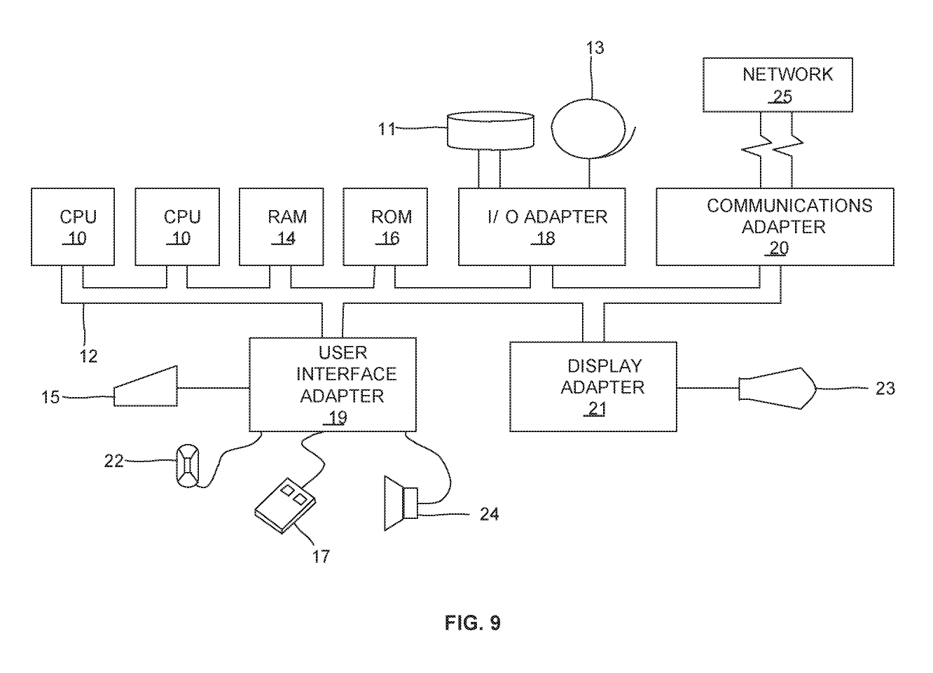

A representative hardware environment for practicing the embodiments herein is depicted in FIG. 9. This schematic drawing illustrates a hardware configuration of a computer architecture/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The system 100 can be used for enabling the secure transaction between the first user 102 and the second user 108. Using the system, the first user 102 can provide authentication to the second device 106 without sharing any authentication details. The transaction between the users is secured when compared to the other authentication systems.

The description of the specific embodiments herein so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the invention.

What is claimed is:

1. A system for enabling a secure transaction between a first user and a second user, said system comprising:
a first device, comprising:
(i) a memory that stores (a) database, (b) a set of modules, and (c) instructions;
(ii) a processor which when configured by said instructions executes said set of modules, wherein said set of modules comprise:
(a) a first device token obtaining module, implemented by said processor, that obtains a first long token that is specific to said first device;
(b) a first device encryption key obtaining module, implemented by said processor, that obtains a first encryption key that is specific to said first device;
(c) a first device long token communicating module, implemented by said processor, that communicates said first long token to a second device;
(d) a first device long token receiving module, implemented by said processor, that receives a second long token from said second device;
(e) a first device payment transfer information receiving module, implemented by said processor, that receives payment transfer information from said second device, wherein said payment transfer information comprises said second long token of said second device;
(f) a first device transaction information encryption module, implemented by said processor, that encrypts transaction information with said first encryption key of said first device;
(g) a first device encrypted transaction information associating module, implemented by said processor, that associates said encrypted transaction information with said payment transfer information; and
(h) a first device payment transfer information communicating module, implemented by said processor, that communicates said payment transfer information with said encrypted transaction information to said second device.

2. The system of claim 1, wherein said second device comprises:
(i) a memory that stores (a) database, (b) a set of modules, and (c) instructions;
(ii) a processor which when configured by said instructions executes said set of modules, wherein said set of modules comprise:
(a) a second device long token receiving module, implemented by said processor, that receives said first long token from said first device;
(b) a second device transaction information associating module, implemented by said processor, that
(i) allows said second user to at least one of (a) enter said transaction information, or (b) approve said transaction information; and
(ii) associates said transaction information with said payment transfer information;
(c) a second device payment transfer information communicating module, implemented by said processor, that communicates said payment transfer information with said transaction information to said first device; and
(d) a second device payment transfer information receiving module, implemented by said processor, that receives said payment transfer information with said encrypted transaction information from said first device.

3. The system of claim 2, wherein said second device further comprises a second device token associating module, implemented by said processor, that
(i) associates said first long token with said payment transfer information; or
(ii) associates said second long token with said payment transfer information.

4. The system of claim 2, herein said second device further comprises a second device long token communicating module, implemented by said processor, that communicates said second long token to said first device.

5. The system of claim 1, wherein said first device is a payee device.

6. The system of claim 1, wherein said first device is a payer device.

7. The system of claim 5, wherein said second device is said payer device when said first device is said payee device.

8. The system of claim 6, wherein said second device is said payee device when said first device is said payer device.

9. The system of claim 1, wherein said first device further comprises a first device transaction information approval module, implemented by said processor, that (a) approves said transaction information, or (b) allows entering of said transaction information.

10. The system of claim 1, wherein said first device further comprises a first device transaction reporting module, implemented by said processor, that reports said transaction between said first user and said second user to a transacting server when internet access is available.

11. The system of claim 10, wherein said second device comprises a second device transaction reporting module, implemented by said processor, that reports said transaction between said second user and said first user to said transacting server when said internet access is available.

12. The system of claim 1, wherein said payment transfer information further comprises a transaction amount.

13. The system of claim 1, wherein said encrypted transaction information comprises at least one of (a) a password, (b) said transaction amount that is to be transacting from said first user to said second user or from said second user to said first user, or (c) authentication information.

14. The system of claim 1, wherein said first device comprises a payment transfer information verification module that verifies said payment transfer information whether said payment transfer information is encrypted using predefined rules of encryption, or wherein said payment transfer information verification module further verifies said second long token received from said second device that meets said predefined rules for a long token.

15. A system for enabling a secure transaction between a first user and a second user, said system comprising:
a first device comprising:
(i) a memory that stores (a) database, (b) a set of modules, and (c) instructions;
(ii) a processor which when configured by said instructions executes said set of modules, wherein said set of modules comprise:
(a) a first device long token receiving module, implemented by said processor, that receives a second long token from a second device;
(b) a first device token associating module, implemented by said processor, that
(a) associates said second long token with payment transfer information; or
(b) associates a first long token with said payment transfer information;
wherein said payment transfer information comprises said first long token of said first device, said second long token of said second device, or a transaction amount;
(c) a first device long token communicating module, implemented by said processor, that communicates said first long token to said second device;
(d) a first device transaction information associating module, implemented by said processor, that
(i) allows said first user to at least one of (a) enter said transaction information, or (b) approve said transaction information; and
associates said transaction information with said payment transfer information;
(e) a first device payment transfer information communicating module, implemented by said processor, that communicates said payment transfer information with said transaction information to said second device; and
(f) a first device payment transfer information receiving module, implemented by said processor, that receives said payment transfer information with encrypted transaction information from said second device.

16. The system of claim 15, wherein said second device comprises:
(i) a memory that stores (a) database, (b) a set of modules, and (c) instructions;
(ii) a processor which when configured by said instructions executes said set of modules, wherein said set of modules comprise:
(a) a second device token obtaining module, implemented by said processor, that obtains said second long token that is specific to said second device;
(b) a second device encryption key obtaining module, implemented by said processor, that obtains a second encryption key that is specific said second device;
(c) a second device long token communicating module, implemented by said processor, that communicates said second long token to said first device;
(d) a second device long token receiving module, implemented by said processor, that receives said first long token from said first device;
(e) a second device payment transfer information receiving module, implemented by said processor, that receives said payment transfer information from said first device;
(f) a second device transaction information encryption module, implemented by said processor, that encrypts said transaction information with said second encryption key of said second device;
(g) a second device encrypted transaction information associating module, implemented by said processor, that associates said encrypted transaction information with said payment transfer information; and
(h) a second device payment transfer information communicating module, implemented by said processor, that communicates said payment transfer information with said encrypted transaction information to said first device.

17. The system of claim 15, wherein said first device is a payer device, and wherein said second device is said payee device when said first device is said payer device, wherein said first device is a payee device, and wherein said second device is said payer device when said first device is said payee device.

18. The system of claim 15, wherein said second device further comprises
(a) a second device transaction information approval module, implemented by said processor, that (a) approves said transaction information, or (b) allows entering of said transaction information;
(b) a second device transaction reporting module, implemented by said processor, that reports said transaction between said second user and said first user to a transacting server when internet access is available; and
(c) a payment transfer information verification module that verifies said payment transfer information whether said payment transfer information is encrypted using predefined rules of encryption, wherein said payment transfer information verification module further verifies that said first long token received from said first device that meets said predefined rules for a long token.

19. A computer implemented method for enabling a secure transaction between a first user and a second user, said method comprising:
obtaining, using a first device, a first long token that is specific to said first device;
obtaining, using said first device, a first encryption key that is specific to said first device;
communicating, using said first device, said first long token to a second device;
associating, using said second device, said first long token or a second long token with payment transfer information, wherein said payment transfer information comprises at least one of (a) said first long token of said first device, (b) said second long token of said second device, or a transaction amount;
associating, using said second device, transaction information with said payment transfer information;
communicating, using said second device, said payment transfer information with said transaction information to said first device;
encrypting, using said first device, said transaction information using said first encryption key of said first device;
associating, using said first device, said encrypted transaction information with said payment transfer information in said first device, and
communicating, using said first device, said payment transfer information with said encrypted transaction information to said second device.

20. The computer implemented method of claim 19, further comprises
verifying that said first user or said second user enters said first short token and said transaction information that is matched by unencrypted part of said payment transfer information in said second device;
verifying said payment transfer information whether said payment transfer information are encrypted using predefined rules of encryption; and
verifying said second long token received from said second device that meets said predefined rules for a long token.
